(19) United States
(12) Patent Application Publication
(10) Pub. No.: US 2026/0302111 A1
(43) Pub. Date: Oct. 1, 2026

(54) SPRING ELEMENT FOR A TEMPERATURE-DEPENDENT SWITCH, AND TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 19/574,967

(22) Filed: Mar. 23, 2026

(30) Foreign Application Priority Data
Mar. 26, 2025 (DE) 10 2025 111 653.9

(51) Int. Cl. H01H 37/52; H01H 37/04

(52) U.S. Cl. CPC H01H 37/52; H01H 37/04

(57) ABSTRACT

A spring element for a temperature-dependent switching mechanism of a temperature-dependent switch. The spring element comprises a central portion having a convexly curved upper side and a concavely curved lower side, an annular support portion that surrounds the central portion and is separated therefrom by an annular gap, and a plurality of webs arranged in a circumferential direction. Each of the webs bridges the gap such that a radially inner end of the respective web is connected to a radially outer edge of the central portion, which extends in the circumferential direction, and a radially outer end of the respective web is connected to a radially inner edge of the annular support portion, which extends in the circumferential direction.

### CROSS-REFERENCE TO RELATED APPLICATIONS

This application claims priority from German patent application DE 10 2025 111 653.9 filed on Mar. 26, 2025. The entire content of this priority application is incorporated herein by reference.

### FIELD

This disclosure relates to a spring element for a temperature-dependent switching mechanism of a temperature-dependent switch. Furthermore, the present disclosure relates to a temperature-dependent switch, in whose temperature-dependent switching mechanism the spring element is used.

Exemplary temperature-dependent switches are known from DE 10 2013 109 291 A1 and DE 10 2023 127 594 B3.

Such temperature-dependent switches serve in a manner known per se to monitor the temperature of a device. For this purpose, the switch is, for example, brought into thermal contact with the device to be protected via one of its outer surfaces, so that the temperature of the device to be protected influences the temperature of the switching mechanism arranged inside the switch.

The switch is typically connected electrically in series into the supply circuit of the device to be protected via connecting lines, so that below the response temperature of the switch, the supply current of the device to be protected flows through the switch.

The temperature-dependent switching mechanism arranged inside the switch provides the temperature-dependent switching behavior of the switch. In the closed switch state, the switching mechanism presses a movable contact part against at least one stationary contact, thus establishing an electrical connection between the two external terminals of the switch. In the open switch state, however, the switching mechanism keeps the movable contact part spaced apart from the at least one stationary contact, so that the electrical connection between the two external terminals of the switch is disconnected.

The switching behavior, i.e., the switching between the closed switch state and the open switch state, occurs in a temperature-dependent manner. A bimetallic element is typically responsible for the temperature-dependent switching behavior of the switching mechanism, which in a known manner switches or snaps in a temperature-dependent manner in the manner of a hysteresis between two configurations, a low-temperature configuration or a low-temperature position and a high-temperature configuration or a high-temperature position.

If the temperature of the bimetallic element increases as a result of a temperature increase in the device to be protected above a defined temperature, which is referred to as the response temperature or switching temperature of the bimetallic element, the bimetallic element snaps from its low-temperature configuration to its high-temperature configuration, thereby causing a switching operation closed switch state to the open switch state or vice versa. Depending on the type of installation, the switch can be designed such that it is in the closed switch state below the response or switching temperature, which is referred to as “normally closed”, or instead is then in the open switch state, which is typically referred to as “normally open”.

In most of these temperature-dependent switches, a spring element is used in the temperature-dependent switching mechanism in addition to the bimetallic element. This spring element is typically referred to as a “temperature-independent spring element” because, unlike the bimetallic element, its behavior is independent of temperature.

This spring element typically serves to relieve the bimetallic element, both mechanically and electrically. In the closed switch state, it typically exerts the contact pressure by means of which the movable contact part is pressed against the at least one stationary contact. In addition, it conducts the electric current in the closed switch state. In the case of using such a spring element, the bimetallic element can thus be mounted mechanically force-free in the closed switch state and, moreover, does not have to serve as a current-carrying component. This has an enormously positive effect on the service life of the bimetallic element.

The spring element is often designed as a snap disc and has a convex-concave shape. In the switches known from DE 10 2013 109 291 A1 and DE 10 2023 127 594 B3, the spring element is firmly fixed or clamped with its edge in the switch housing. More precisely, the spring element is clamped between the cover part and the lower part inside the switch, wherein for clamping the spring element a spacer ring is used, which is arranged between the cover part and the lower part inside the switch housing.

The clamping of the spring element at the edge ensures that the spring element is in permanent contact with one of the two electrodes of the switch (here with the current-carrying lower part of the switch). This is intended in particular to prevent the outer edge of the spring element from lifting off the electrode during the switching operation, which can lead to contact erosion due to arcing. At the same time, the spring element is to be fixed symmetrically at the edge, so that the spring element exhibits a mechanically uniform switching behavior. In addition, the edge fixation and the associated permanent contact with one of the two electrodes is intended to reduce the contact resistance between the spring element and the electrode, whereby the performance of the switch as a whole can be increased and the spring element has a longer service life.

Due to the clamping of the spring element at the edge, however, the spring element must also overcome additional forces that arise due to the clamping during the switching operation. In the switches disclosed in DE 10 2013 109 291 A1 and DE 10 2023 127 594 B3, several compensation sections are therefore provided in the spring element, which allow a radial compensation movement of the spring element during the switching operation. These compensation sections allow in particular the internal deformation that occurs in the spring element during a switching operation to be compensated, so that the resulting internal stresses can be reduced.

In particular, DE 10 2013 109 291 A1 proposes various possible types of arrangements for these compensation sections. Although the described configurations of the spring elements with various alternatively proposed arrangements of the compensation sections have already proven themselves in practice for such switches, there is still room for improvement. The proposed configurations of the spring elements have proven to be relatively complex to manufacture. In addition, there was also a desire to further improve the spring elements with regard to the homogeneity of the switching behavior and the force distribution.

### SUMMARY

It is an object to provide a spring element and a temperature-dependent switch with such a spring element, with which the above-mentioned disadvantages can be overcome or at least largely eliminated. It is in particular an object to provide a spring element that meets the above-mentioned requirements for such temperature-dependent switches, is comparatively simple to manufacture, and is further improved in terms of homogeneity of the switching behavior and force distribution.

According to a first aspect, a spring element for a temperature-dependent switching mechanism of a temperature-dependent switch is presented, the spring element comprising:
a central portion having a convexly curved upper side and a concavely curved lower side;
an annular support portion surrounding the central portion;
an annular gap separating the central portion from the annular support portion; and
a plurality of webs distributed circumferentially around the central portion about a central axis of the spring element in a circumferential direction,
wherein each web extends across the annular gap and has a radially inner end connected to a radially outer edge of the central portion, and a radially outer end connected to a radially inner edge of the annular support portion.

In contrast to the arrangements of the spring element known from DE 10 2013 109 291 A1, the spring element is easier to manufacture because it is altogether simpler in construction. Specifically, the webs are no longer radially offset inwards relative to the gap that separates the support portion from the central portion, as is proposed in DE 10 2013 109 291 A1, but instead directly bridge the annular gap. The webs thus connect radially to the outer or outermost edge of the central portion and connect it to the radially inner edge of the annular support portion. As a result, the annular gap can be designed as a continuous (uninterrupted) gap in the circumferential direction, which is merely bridged by the webs.

The annular gap can also be referred to as an “annular separating slot”.

This type of arrangement increases the overall movability of the spring element many times over. At the same time, the stresses induced inside the spring element during a switching operation are reduced or at least distributed much more homogeneously over the entire surface of the spring element.

According to a refinement, the central portion is circular-disc-shaped or annular in a plan view, wherein the annular gap and the annular support portion are each annular in the plan view.

In other words, the radially outer edge of the central portion preferably forms a closed circle. Likewise, the radially inner edge of the annular support portion forms a closed circle. The closed circle formed by the radially inner edge of the annular support portion is preferably concentric with the circle formed by the radially outer edge of the central portion. The diameter of the circle formed by the radially inner edge of the annular support portion is larger than the diameter of the circle formed by the radially outer edge of the central portion.

This type of arrangement creates a circular-disc-shaped or annular inner region of the spring element, which is formed by the central portion. Depending on whether the spring element comprises a hole at its center or not, the central portion is annular or circular-disc-shaped. In both cases, the arrangement of the spring element ensures a uniform and even internal force distribution in the spring element.

As an alternative to a circular-disc-shaped or annular configuration of the central portion, an oval configuration thereof is also conceivable, although this appears somewhat less favorable with regard to the homogeneity of the force distribution.

The radially outer edge of the central portion as well as the radially inner edge of the annular support portion are in both cases preferably located on a closed, rounded contour without corners and run concentrically to each other. The gap running therebetween is accordingly in both cases a continuous, uninterrupted gap in the circumferential direction, which is bridged by the webs.

According to a further refinement, the annular support portion has on its lower side a planar bearing surface which lies in a planar plane along the entire circumference.

This has the particular advantage that the spring element can be placed with this completely circumferential planar bearing surface on a flat surface and thereby has full-surface contact with the ground along the entire circumference of the spring element. This creates a comparatively large bearing surface, by which the current-carrying capacity can be increased and the contact resistance can be reduced. Moreover, this leads to a mechanically stable support of the spring element, which allows for an optimal and evenly distributed force absorption.

According to a further refinement, the webs are resiliently formed in a radial direction oriented orthogonally to the circumferential direction.

This elastically resilient configuration of the webs in the radial direction allows the internal stresses arising in the spring element during a switching operation to be reduced, thereby increasing the overall movability of the spring element, in particular the movability of the central portion relative to the support portion.

According to a further refinement, the webs project in a respective central web portion relative to the radially inner end of the respective web and the radially outer end of the respective web in a direction orthogonal to the circumferential direction and the radial direction of the spring element. The webs preferably project upwards in their respective central web portion, i.e., on the same side as the upper side of the central portion. The webs can thus deflect upwards during a switching operation to ensure the radial spring properties.

According to a further refinement, the webs comprise an angular bend in a cross-sectional view. This cross-section is preferably the cross-section that divides the cross-section into two equal halves and runs along the radial direction.

The “angular bend” means an angled section. Such an angular bend contributes in a simple and advantageous manner to the elastically resilient properties of the webs in the radial direction.

According to a further refinement, the angular bend on each of the webs extends, in a plan view, along an arcuate bend line which is oriented in the circumferential direction.

This bend line is a line along which the angular bend runs. This is preferably a symmetry line of the angular bend. Since this runs in the circumferential direction of the spring element, the radially acting forces can be optimally compensated by the angular bend, so that the central portion of the spring element is resiliently movable as homogeneously and direction-independently as possible relative to the support portion.

According to a further refinement, the webs are each connected to the central portion and the annular support portion by a material bond or are integrally formed with the central portion and the annular support portion.

According to the first alternative (material-bond connection), the webs can be, for example, soldered or welded. The second alternative of an integral formation of the entire spring element including the central portion, webs, and support portion is preferred, however, as this increases the stability and spring elasticity of the spring element as a whole.

According to a further refinement, the webs comprise at least three webs.

For example, the spring element comprises exactly three webs or exactly four webs. This ensures a mechanically stable connection between the central portion of the spring element and the support portion of the spring element.

According to a further refinement, the central portion comprises, at its center, a hole or a contact element projecting from the upper side.

The aforementioned second alternative corresponds to a direct attachment of the movable contact part to the spring element. According to the first-mentioned variant, the movable contact part is passed through the hole in the central portion in the assembled state of the temperature-dependent switch. In this case, the spring element can be slipped with its central hole loosely over the movable contact part in the assembled state of the switch, be captively but with play attached thereto, or be fixedly connected to the movable contact part.

According to a further refinement, the spring element is configured to be rotationally symmetrical with respect to a central longitudinal axis.

This also ensures a uniform, direction-independent force distribution. In addition, a degree of freedom (rotation about the central longitudinal axis of the spring element) is thereby intentionally left open during assembly.

According to a further refinement, at least a portion of the spring element is made of steel or copper-beryllium.

According to a further refinement, the annular support portion is coated on its lower side with a metal layer which has a higher electrical conductivity compared to steel or copper-beryllium.

This refinement has the particular advantage that the conductivity of the current-carrying surfaces of the spring element is additionally increased by the additional coating on the lower side of the annular support portion. This further reduces the contact resistance, whereby an additional increase in the performance of the switch in which the spring element is used can be achieved. A particular advantage of this refinement arises in comparison to conventional spring elements, which are coated as a whole with a metal layer of higher electrical conductivity. Typically, silver is used for this purpose. In the present case, however, it is not necessary to coat the entire spring element, but it is sufficient to coat only the lower side of the annular support portion with silver. This can significantly reduce silver consumption. This understandably leads to enormous cost advantages.

According to a second aspect, a temperature-dependent switch is presented, comprising:
two external terminals; and
a temperature-dependent switching mechanism configured to switch, depending on its temperature, between a closed switch state in which an electrically conductive connection between the two external terminals is established and an open switch state in which the electrically conductive connection is interrupted, wherein the temperature-dependent switching mechanism comprises a spring element comprising:
a central portion having a convexly curved upper side and a concavely curved lower side;
an annular support portion surrounding the central portion;
an annular gap separating the central portion from the annular support portion; and
a plurality of webs distributed circumferentially around the central portion about a central axis of the spring element in a circumferential direction,
wherein each web extends across the annular gap and has a radially inner end connected to a radially outer edge of the central portion, and a radially outer end connected to a radially inner edge of the annular support portion.

Here, it is preferred that the annular support portion of the spring element is permanently fixed in position, in particular clamped, in the switch. “Permanently” means that the fixing of the position or clamping of the annular support portion of the spring element occurs permanently, both in the open switch state and in the closed switch state. In this case, it is particularly preferred that the annular support portion is clamped between a spacer ring and a lower part of the switch housing.

Furthermore, it is preferred that the switching mechanism comprises a stationary contact and a movable contact part, wherein the spring element is operatively connected to the movable contact part such that it presses the movable contact part against the stationary contact in the closed switch state and/or keeps it spaced apart from the stationary contact in the open switch state.

It is understood that the features mentioned above and those yet to be explained below can be used not only in the combination specified in each case, but also in other combinations or in isolation, without departing from the spirit and scope of the present disclosure.

### BRIEF DESCRIPTION OF THE DRAWINGS

FIG. 1 shows a first embodiment of a spring element in a plan view from above;

FIG. 2 shows a sectional view of the spring element shown in FIG. 1 according to the first embodiment;

FIG. 3 shows a sectional view of the spring element according to a second embodiment;

FIG. 4 shows a schematic sectional view of a first embodiment of a switch, wherein the switch is in the closed switch state; and

FIG. 5 shows a schematic sectional view of the switch shown in FIG. 4, wherein the switch is in the open switch state.

### DESCRIPTION OF PREFERRED EMBODIMENTS

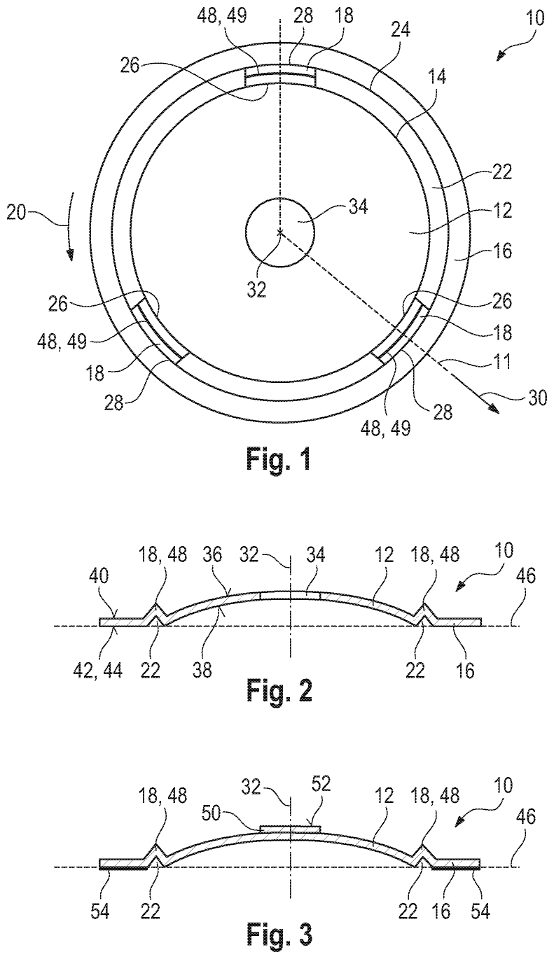

FIGS. 1 and 2 show a first embodiment of the spring element. The spring element is designated therein in its entirety by the reference numeral 10. FIG. 1 shows the spring element 10 in a plan view from above. FIG. 2 shows the spring element 10 in a sectional view along the line 11 indicated by a dashed line in FIG. 1.

The spring element 10 is typically made of metal. It is particularly preferred that the spring element 10 is made of steel or copper-beryllium.

The spring element 10 comprises a centrally or centrally arranged portion, which is referred to herein as “central portion” 12. This central portion 12 is circular-disc-shaped or annular in a plan view from above. It comprises a radially outer edge 14 which lies on a circular line along its entire circumference. The radially outer edge 14 of the central portion 12 can thus be referred to as a circular edge.

In addition to the central portion 12, the spring element 10 comprises a support portion 16. This support portion 16 is configured to be annular. The annular support portion 16 completely surrounds the central portion 12 and is connected to the central portion 12 via three webs 18, which are arranged distributed in the circumferential direction 20.

Between the central portion 12 and the annular support portion 16, a gap 22 is arranged, which surrounds the entire circumference of the central portion and is bridged by the webs 18.

The radially inner edge 24 of the support portion 16 forms the radially outer end of the gap 22. Since this radially inner edge 24 of the support portion 16 is a circular edge that lies on a circular line which is concentric with the circular line on which the radially outer edge 14 of the central portion 12 lies, the gap also has the shape of a circular ring.

The webs 18 each adjoin with their radially inner ends 26 directly to the circular outer edge 14 of the central portion 12 and adjoin with their radially outer ends 28 each to the circular inner edge 24 of the support portion 16. In this respect, a width of the annular gap 22 measured in the radial direction 30 corresponds to a respective length of the webs 18 measured in the radial direction 30.

The radial direction 30 is indicated in FIG. 1 by an arrow. This radial direction 30 runs orthogonally to the circumferential direction 20 and also orthogonally to a central longitudinal axis 32 of the spring element 10.

The spring element 10 is preferably, as shown in FIG. 1, rotationally symmetrical with respect to the central longitudinal axis 32. In the embodiment shown here, in which the spring element 10 comprises a total of three webs 18, these are offset from each other by an angle of 120°. Accordingly, the spring element 10 is 120°-rotationally symmetrical with respect to the central longitudinal axis 32. It is understood, however, that depending on the number of webs 18, a correspondingly different rotational symmetry results, e.g., 90°-rotationally symmetrical for four webs 18 or 60°-rotationally symmetrical for six webs 18.

In the center of the spring element 10, which at the same time forms the center of the central portion 12, a hole 34 is provided according to the first embodiment shown in FIGS. 1 and 2. This hole 34 surrounds the central longitudinal axis 32.

As can be seen in particular from the sectional view in FIG. 2, the central portion 12 of the spring element 10 has a convex-concave curved cross-sectional shape. The central portion 12 comprises a convexly curved upper side 36 and a concavely curved lower side 38, which is opposite to the upper side 36 and faces away from it. Viewed in cross-section, the upper side 36 and the lower side 38 of the central portion 12 are each arcuately curved. It is particularly preferred that the upper side 36 and the lower side 38 of the central portion 12 run parallel to each other, so that the spring element 10 has a constant wall thickness in the region of the central portion 12.

The circumferential annular support portion 16, however, is a planar or flat portion which, viewed in cross-section, runs in a straight line (see FIG. 2). Both the upper side 40 and the lower side 42 of the annular support portion 16 each lie in a planar plane.

The lower side 42 forms an annular, planar bearing surface 44, which lies in a planar plane along the entire circumference of the spring element 10, which is indicated by a dashed line in FIG. 2 and provided with the reference numeral 46.

The concavely curved lower side 38 of the central portion 12 does not lie in this planar plane 46, but projects therefrom.

The webs 18 in the first embodiment shown in FIGS. 1 and 2 are integrally formed with the central portion 12 and the annular support portion 16. They each comprise, in cross-section, an angular bend 48, which is preferably acute-angled in cross-section. As a result, the webs 18 each project upwards and run above the annular gap 22 (see FIG. 2).

In the plan view from above shown in FIG. 1, the angular bends 48 of the individual webs extend each along an arcuate bend line 49, which is oriented in the circumferential direction 20.

The angular bends 48 are created by a kind of notch, which is drawn into the webs 18 from below in a circumferential manner. This results in a material tapering in the area of the angular bend 48 of the respective web 18, i.e., a point that has a smaller material thickness (thickness) than the other parts of the spring element 10. This in turn leads to the webs 18 being elastically resilient in the radial direction 30. This allows the central portion 12 of the spring element 10 to deform elastically, in particular relative to the circumferential annular support portion 16.

In particular, in a case where the spring element 10 is firmly clamped at its annular, circumferential support portion 16, the central portion 12 can snap from its convex-concave curvature shown in FIG. 2 upwards to a concave-convex curvature downwards. The spring element 10 can, in other words, be designed as a bistable snap disc, which has a stable first geometric configuration and a stable second geometric configuration different therefrom. The forces arising during this snapping can be cushioned by the webs 18.

FIG. 3 shows a second embodiment of the spring element 10. This second embodiment differs from the first embodiment shown in FIGS. 1 and 2 essentially in that, instead of a centrally arranged hole 34, a contact element 50 is provided. This contact element 50 is arranged centrally on the central portion 12.

In the embodiment shown in FIG. 3, the contact element 50 is integrally or monolithically formed with the central portion 12 of the spring element 10. However, it can in principle also be connected to it by a material bond.

The contact element 50 comprises on its upper side a contact surface 52, which serves for electrical contacting. With this contact surface 52, the spring element 10, as will be shown in detail below, rests against a stationary contact in the closed switch state. The contact element 50 therefore projects upwards from the upper side 36 of the central portion 12 of the spring element 10.

In the first embodiment shown in FIG. 2, in which a centrally arranged hole 34 is provided instead, a separate contact element, which can have a similar shape as the contact element 50, is passed through the hole 34.

A further difference of the second embodiment shown in FIG. 3 is that the lower side 42 of the annular support portion 16 is provided with a coating. This coating comprises a metal layer 54 which, in comparison to the material from which the rest of the spring element 10 is made (e.g., steel or copper-beryllium), has an increased electrical conductivity. This allows the contact resistance of the spring element 10 to be reduced. It is understood that the metal layer 54 can also be arranged on the spring element 10 according to the first embodiment shown in FIGS. 1 and 2.

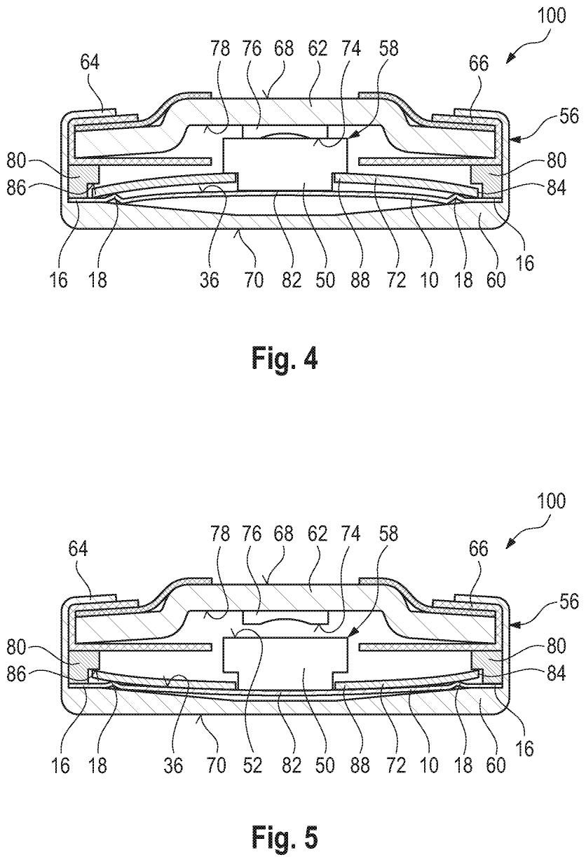

FIGS. 4 and 5 show a first embodiment of a temperature-dependent switch. The switch is designated therein in its entirety by the reference numeral 100. FIG. 4 shows the closed switch state of the switch 100. FIG. 5 shows the open switch state of the switch 100.

The switch 100 comprises a switch housing 56, in the interior of which a temperature-dependent switching mechanism 58 is arranged. The switch housing 56 includes a cup-shaped lower part 60 and a cover part 62, which is held on the lower part 60 by a bent or flanged upper edge 64.

The lower part 60 as well as the cover part 62 are made of an electrically conductive material, preferably of metal. An insulating film 66 is arranged between the lower part 60 and the cover part 62. The insulating film 66 provides for electrical insulation of the lower part 60 with respect to the cover part 62. Likewise, the insulating film 66 provides for a mechanical seal that prevents liquids or contaminants from entering the interior of the switch housing 56 from the outside.

Since the lower part 60 and the cover part 62 in this example are each made of electrically conductive material, thermal contact with a device to be protected can be established via their outer surfaces. The outer surfaces also serve as the electrical connection of the switch 100. Thus, for example, the outer surface 68 of the cover part 62 can function as a first external terminal and the outer side 70 of the lower part 60 can function as a second external terminal of the switch 100.

The switching mechanism 58 is arranged clamped between the lower part 60 and the cover part 62. The switching mechanism 58 comprises a bimetallic element 72 in addition to the spring element 10. The spring element 10 corresponds essentially to the embodiment as shown in FIG. 3, in which the movable contact part 50 is integrally formed with the spring element 10 or is attached to its upper side by a material bond. The movable contact part 50 in this embodiment of the switch 100 merely has a slightly different shape. Compared to the embodiment shown in FIG. 3, the contact part 50 is configured to be somewhat larger and has a T-cross-sectional shape.

The bimetallic element 72 is held captively but with play on the movable contact part 50. A central through hole provided in the bimetallic element 72 has an inner diameter that is slightly larger than an outer diameter of the movable contact part 50, which is pronounced in the lower region. Since the outer diameter of the movable contact part 50 in its upper region is, however, larger than this inner diameter of the through hole arranged in the bimetallic element 72, and the spring element 10 is arranged below the bimetallic element 72 and is fixedly connected to the movable contact part 50, the bimetallic element 72 cannot unintentionally detach from the switching mechanism 58 despite its freedom of movement. The spring element 10, the bimetallic element 72, and the movable contact part 50 thus form a captive unit of the switching mechanism 58, which can be inserted as a whole into the switch housing 56 during the assembly of the switch 100.

In the closed switch state shown in FIG. 4, the spring element 10 presses the contact surface 52 arranged on the upper side of the contact part 50 against a contact surface 74, which is arranged on the lower side of a stationary contact part 76. The stationary contact part 76 is arranged on a lower side 78 of the cover part 62 facing the lower part 60.

In the region of its radially outer edge, the spring element 10 is clamped with its circumferential, annular support portion 16 in the switch housing 56. More precisely, the support portion 16 is clamped between a spacer element 80, which in the present embodiment is configured as a spacer ring, and the lower part 60 of the switch housing 56. The spacer ring 80 is in turn also clamped in the switch housing 56 and arranged directly between the spring element 10 and the insulating film 66.

The support portion 16 of the spring element 10 is thus permanently clamped in the switch housing 56, independently of the switch state of the switching mechanism 58. In this respect, the spring element 10 is in permanent galvanic contact with the second external terminal 70 of the switch 100. In the closed switch state shown in FIG. 4, the spring element 10 is also in galvanic contact with the first external terminal 68 of the switch 100, as it presses the movable contact part 50, which is arranged in the central region 82 of the spring element, from below against the stationary contact part 76. In this closed switch state of the switch 100, the bimetallic element 72 rests from above on the upper side 36 of the spring element 10. The contact pressure is, however, preferably generated by the spring element 10, whereby the bimetallic element 72 is relieved.

If the temperature of the device to be protected and thus the temperature of the switch 100 and of the bimetallic element 72 arranged therein now increases to or beyond the switching or response temperature of the bimetallic element 72, the bimetallic element 72 snaps from its convex low-temperature configuration shown in FIG. 4 into its concave high-temperature configuration, which is shown in FIG. 5. During this snapping, the bimetallic element 70 is supported with its outer edge 84 from below on a support surface 86, which is arranged on the spacer element 80. At the same time, the bimetallic element 72 presses with its center 88 the spring element 10 downwards in its central region 82. During this switching movement, the bimetallic element 72 thus, in other words, exerts a force that acts contrary to the actuating force which the spring element 10 exerts on the movable contact part 50 in the closed switch state. Due to this force, the spring element 10 also snaps from its first, convex shape on the upper side 36 shown in FIG. 4 into its concave shape on the upper side 36 shown in FIG. 5. The movable contact part 50 is thereby lifted off the stationary contact part 76. The current flow through the switch is thereby interrupted. The switch 100 is thus in the open switch state.

The webs 18, which are elastically resilient in the radial direction, give the spring element 10 the possibility to expand mechanically at the time of snapping from the situation shown in FIG. 4 into the situation shown in FIG. 5, despite its clamping at the edge. The webs 18 of the spring element thus act as compensation sections, which allow an expansion and compression of the spring element 10 in the radial direction, whereby in particular internal stresses or deformations of the spring element 10 are avoided or at least reduced during the switching operation.

At the same time, the firm clamping of the support portion 16 of the spring element 10 and the resulting permanent mechanical and electrical connection between the spring element 10 and the switch housing 56 have the advantage that sparking and/or arcing cannot occur during a switching operation, as is often the case with switching mechanisms in which the spring element 10 lifts off at the edge from the inner bottom surface of the switch housing lower part 60 during the switching operation. Contact erosion can thereby be effectively avoided. Due to the webs 18 acting as compensation sections, the movability of the spring element 10 is, however, maintained.

Finally, it should be mentioned that, depending on the desired design, the temperature-dependent switching mechanism 58 can be configured either as explained before, namely that the switching mechanism 58 assumes the open switch state shown in FIG. 4 below the switching temperature of the bimetallic element 70, or vice versa. In the first case, one speaks of a switch with the configuration “normally closed”. In the second case, one speaks of a switch with the configuration “normally open”.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A spring element for a temperature-dependent switching mechanism of a temperature-dependent switch, the spring element comprising:
a central portion having a convexly curved upper side and a concavely curved lower side;
an annular support portion surrounding the central portion;
an annular gap separating the central portion from the annular support portion; and
a plurality of webs distributed circumferentially around the central portion about a central axis of the spring element in a circumferential direction,
wherein each web extends across the annular gap and has a radially inner end connected to a radially outer edge of the central portion, and a radially outer end connected to a radially inner edge of the annular support portion.

2. The spring element of claim 1, wherein the radially outer edge of the central portion and the radially inner edge of the annular support portion extend in the circumferential direction and are parallel to each other.

3. The spring element of claim 1, wherein the central portion is circular or annular.

4. The spring element of claim 1, wherein the annular support portion has, on a lower side thereof, a planar bearing surface extending along an entire circumference.

5. The spring element of claim 1, wherein each web is resilient in a radial direction orthogonal to the circumferential direction.

6. The spring element of claim 1, wherein each web comprises a central web portion that is offset relative to the radially inner end and the radially outer end in a direction orthogonal to both the circumferential direction and a radial direction of the spring element.

7. The spring element of claim 1, wherein each web comprises an angular bend.

8. The spring element of claim 7, wherein the angular bend extends along an arcuate bend line oriented in the circumferential direction.

9. The spring element of claim 1, wherein each web is connected to the central portion and to the annular support portion by a material bond or is integrally formed therewith.

10. The spring element of claim 1, wherein the plurality of webs include at least three webs.

11. The spring element of claim 1, wherein the central portion comprises, at a center thereof, a hole or a contact element that protrudes from the upper side.

12. The spring element of claim 1, wherein at least a portion of the spring element is made of an electrically conductive material, and the annular support portion is coated on a lower side with a metal layer having a higher electrical conductivity than that the electrically conductive material.

13. The spring element of claim 1, wherein at least a portion of the spring element is made of metal.

14. The spring element of claim 1, wherein at least a portion of the spring element is made of steel or copper-beryllium.

15. A temperature-dependent switch comprising:
two external terminals; and
a temperature-dependent switching mechanism configured to switch, depending on its temperature, between a closed switch state in which an electrically conductive connection between the two external terminals is established and an open switch state in which the electrically conductive connection is interrupted, wherein the temperature-dependent switching mechanism comprises a spring element comprising:
a central portion having a convexly curved upper side and a concavely curved lower side;
an annular support portion surrounding the central portion;
an annular gap separating the central portion from the annular support portion; and
a plurality of webs distributed circumferentially around the central portion about a central axis of the spring element in a circumferential direction,
wherein each web extends across the annular gap and has a radially inner end connected to a radially outer edge of the central portion, and a radially outer end connected to a radially inner edge of the annular support portion.

16. The temperature-dependent switch of claim 15, wherein the annular support portion is fixed in position within the switch.

17. The temperature-dependent switch of claim 15, wherein the temperature-dependent switching mechanism comprises a stationary contact and a movable contact part, the spring element is operatively connected to the movable contact part to press the movable contact part against the stationary contact in the closed switch state and/or to keep the movable contact part spaced apart from the stationary contact in the open switch state.
